(19) United States
(12) Patent Application Publication
(10) Pub. No.: US 2004/0030821 A1
(43) Pub. Date: Feb. 12, 2004

(54) Portable and interface exchangeable storage system and method for executing the same

(76) Inventor: Yu-Miao Huang Qiu, Taipei (TW)

Correspondence Address: Yu-Miao Huang Qiu, 235 Chung-Ho, Box 8-24, Taipei, TW

(21) Appl. No.: 10/213,911

(22) Filed: Aug. 8, 2002

(51) Int. Cl. G06F 13/36

(52) U.S. Cl. 710/315

(57) ABSTRACT

A portable and interface exchangeable storage system and method thereof used in electronic systems cause that removing of a ATA/ATAPI mass storage device in electronic systems becomes easy and safe without limited by fixed interface and required manual procedure. The portable and interface exchangeable storage system comprises a mass storage device with ATA/ATAPI interface, a portable caddy box with connectors provided with all necessary ATA/ATAPI data, control signal and setup interface, a interface translator with ATA/ATAPI setup function. When a user removes or plug the caddy from or to host system, the portable, and interface exchangeable storage system can simulate necessary steps to host system and provide safe procedure to utilize ATA/ATAPI mass storage device.

### FIELD OF THE INVENTION

The present invention relates to storage systems, and particularly to a portable and interface exchangeable storage system to transform the standard mass storage device of ATA/ATAPI interface into any interface required by host system.

### BACKGROUND OF THE INVENTION

In the modem Internet age, mass information needs to be digitalized to be proceeded, stored, and transmitted by computers, PDAs, mobile phones, and so on. Thus the need for huge volume, high speed, portable, stable, and standard recording medias and storage systems is appreciated. Recently, large volume portable storage systems, such as CD-ROMs, MOs, etc., have been disclosed to provide greater storage capacity and usage. However, because required capacity increases rapidly, while their interfaces are remained without being improved with the increment of storage capacity, it is often tat consumers cannot store all the data in one single storage media.

Presently, one of the frequently used, cheapest and most convenient storage devices is hard disk, but it is poor in portability due to the restrictions of the design thereof. A function called hot plug, or plug-and-play PnP allows users to remove disk units from a computer without turning off its power Then, a removable box is designed to allow a hard disk to be easily removed from a computer. However, when a hard disk is placed within the removable box with the standard ATA/ATAPI interface, we can not utilize the hard disk in many conditions, such as ATA/ATAPI bus must be pre-built insight host system. Also, ATA/ATAPI mass storage device must know itself master or slave, generally, this is a manual setup procedure. In addition, ATA/ATAPI device is not defined with hot plug function, a direct plug may cause ATA/ATAPI device or host system to crash. If a removable box with other interface, like USB or IEEE 1394, will meet similar situation, such as USB or IEEE 1394 must be pre-built insight host system.

### SUMMARY OF INVENTION

The primary object of the present invention is to provide a portable, interface exchangeable storage system with ATA/ATAPI mass storage device for computer, information appliance, or any electronic system.

To achieve above object, the present invention provides a portable and interface exchangeable storage system for communicating an ATA/ATAPI device with a host, The system comprises a caddy connector and an interface translator. The caddy connector is connected to the ATA/ATAPI device located on an ATA/ATAPI device slot. The caddy connector comprise; a connecting body; and a first ATA/ATAPI interface for interfacing the ATA/ATAPI interface on the ATA/ATAPI device slot The interface translator installing between the portable caddy and a host for translating between a general used interface in the host and an ATA/ATAPI interface so that the ATA/ATAPI device is communicated with the host; the interface translator further comprising: a second ATA/ATAPI interface for interfacing with the ATA/ATAPI device on the ATA/ATAPI device slot through the caddy connector, a power unit controlling the power supplied to the ATA/ATAPI device; and a device setup unit for setting the ATA/ATAPI device to the host so as to initiate the ATA/ATAPI device.

### BRIEF DESCRIPTION OF THE DRAWINGS

FIG. 1 shows a basic block diagram of the present invention and how to put an ATA/ATAPI mass storage device into one caddy, and then connect it to a host system computer, or any electronic system.

FIG. 2 shows the component structure of the caddy connector of the present invention.

FIG. 3 shows the component structure of the interface translator of the present invention.

FIG. 4 shows the flow charts of the method to provide safety hot plug method in interface translator according to the present invention.

### DETAILED DESCRIPTION OF THE PREFERRED EMBODIMENT

The present invention is to provide a portable, exchangeable storage system with ATA/ATAPI mass storage device for computer, information appliance, or any other electronic system. The portable storage system comprises a mass storage device. The mass storage device has an ATA/ATAPI interface, a portable caddy, which is a box with connectors provided therein and with all necessary ATA/ATAPI data, control signals, power supply, and setup interface; interface translator for detecting caddy connection to said host system with interface required by host system.

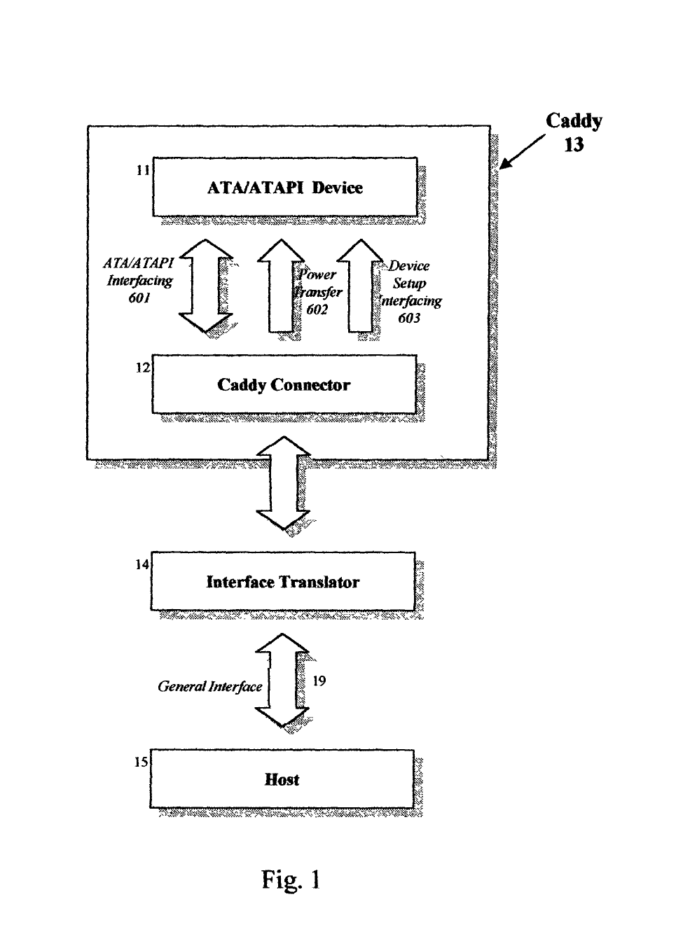

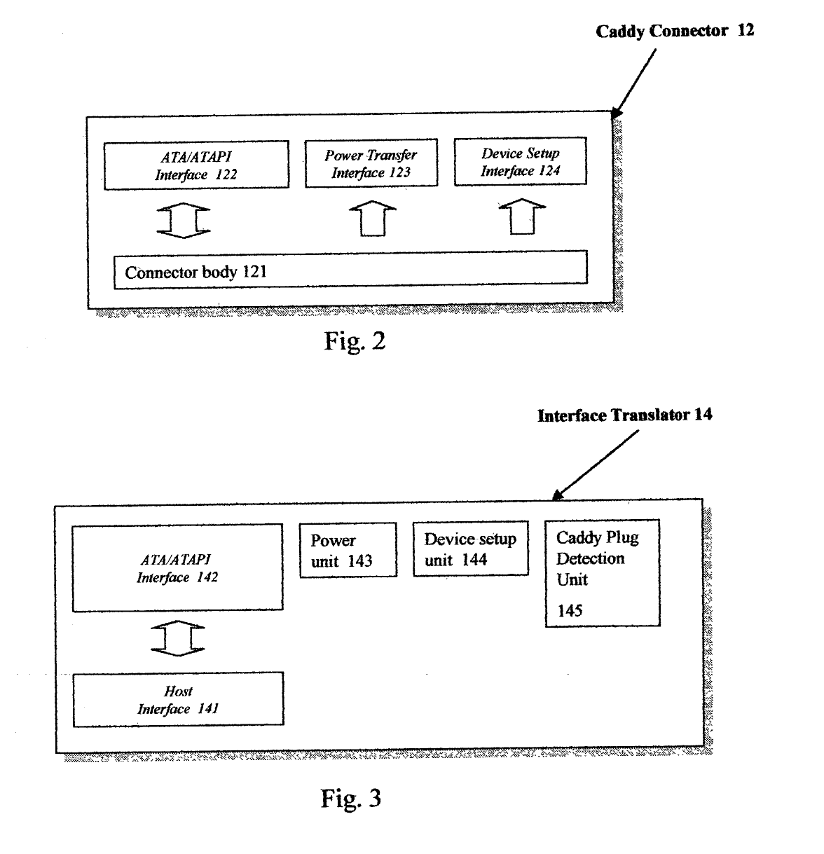

With reference to FIG. 1, a block diagram about the components and connections of the present invention are illustrated and further referring to FIG. 2 and 3, the details of the caddy connector and interface translator 14 are shown. Thereby, the device of the present invention can be clearly understand from these figures by those skilled in the art.

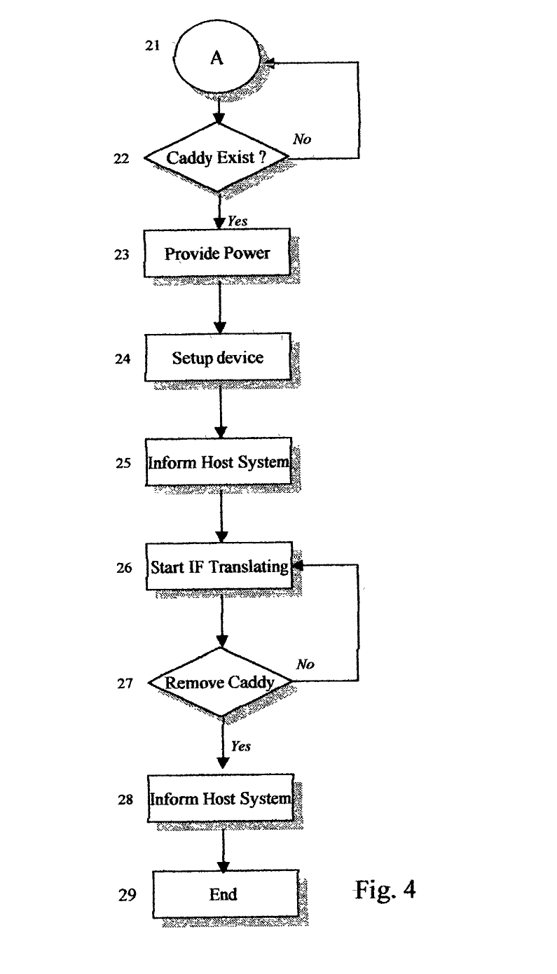

FIG. 1 illustrates one embodiment about the portable and exchangeable storage system according to the present invention, wherein the system provides a connection interface to the host system with the ATA/ATAPI mass storage device. The portable and exchangeable storage system mainly comprises a portable caddy 13 and an interface translator 14. The caddy 13 further comprises an ATA/ATAPI device 11, a caddy connector 12 and a device 11. As illustrated in FIG. 2, the caddy connector 12 has a connector body 121, an ATA/ATAPI interface 122, power transfer interface 123, and device setup interface 124. The interface translator 14 include an ATA/ATAPI interface 142, a power unit 143, a device setup unit 144, caddy plug detect unit 145, and host interface 141. The connector 12 serves to connect the interface translator 14 to an ATA/ATAPI device which is located in caddy 13. The ATA/ATAPI device may be an Hard disk, a Flash, a CDROM, a DVDROM, etc. compatible with the ATA/ATAPI interface. The caddy connector 12 is a connector conformable to the specification of the ATA/ATAPI interface. The interface translator 14 is located between the portable caddy 13 and a host 15 and serves to translate between a general used interface (not shown) in the host and the ATA/ATAPI interface so that the ATA/ATAPI, device is communicated with the host 15. Referring to FIG. 4, the interface translator 14 is connected between the host 15 and the caddy connector 12. Thereby, the interface translator 14 further includes an ATA/ATAPI interface 142 which is used to interface with the ATA/ATAPI device on the ATA/ATAPI device 11 through the caddy connector 12; a power unit 143 controlling the power supplied to the ATA/ATAPI device; a caddy plug detection unit 145 to detect caddy plug-in or out, and a device setup unit 144 for setting the ATA/ATAPI device to the host so as to initiate the ATA/ATAPI device. The system simulates an appropriate interface 19 and responses to host system 15 according to caddy's condition. If a caddy connect to the interface translator, the interface translator will detect by caddy plug detection unit 145 and the host system will be informed to a new mass storage device added. Before that, interface translator 14 will provide proper power 143 to ATA/ATAPI mass storage device to boot up the device, and do necessary setting works 144, such as master/slave selection, and so on. When the host 15 is informed that a new ATA/ATAPI device 11 is connected, some requests are sent to the interface translator 14 from the host 15. Since the host system is communicated with interface translator by other interface, such as USB, IEEE 1394, PCI, SCSI, and so on, such an interface is necessary to be transformed into ATA/ATAPI interface and format, or vice verse.

In the, prior art construction, the interface of general ATA/ATAPI device boxes installed to a host system is fixed with an unsafe way. For example, direct plugging the ATA/ATAPI interface to a host system will cause the ATA/ATAPI device or computer system to be inoperable. In addition, ATA/ATAPI mass storage device needs to know the master or slave of the system by itself. However, this often requires a manual setting operation If the user waits to change the ATA/ATAPI device to other host system, a host system to be used requires the same interface as the former one.

Thereby, there is a demand for an automatic, safe, necessary procedure and interface for utilizing an ATA/ATAPI device, and thus users can plug ATA/ATAPI device to any kind of hosts anytime. In addition, a translator for transforming the ATA/ATAPI interface with other general interfaces, such as USB, SCSI, IEEE 1394, and so on, will help users to bring ATA/ATAPI mass storage device to different type of hosts.

However, from above description, it is known that the present invention can positioned the following works. One is ATA/ATAPI interfacing 601 which builds the interface between the caddy connector 12 of the present invention and the ATA/ATAPI device 11. The second work performed in the present invention is power transfer 602 which control the transfer between the caddy connector 12 and the ATA/ATAPI device 11. The last is a device setup interface 603 which sets up the ATA/ATAPI device, so that the host 15 can actuate the ATA/ATAPI device to achieve the object of the present invention.

FIG. 4 shows the steps of the method using in an embodiment of the present invention. Firstly, the process start in the step (step 21). Then, the interface translator is started to check whether the caddy has been connected thereto or not (step 22). If no, the process goes to the end step 21. Otherwise, the process enters into the step 23, in this step, power is provided If a said caddy exist by plugging operation, the interface translator will start to give power to caddy to boot up ATA/ATAPI device. Then, interface translator will make necessary setup procedure (step 24). This will prevent user's manual operation to ATA/ATAPI device. If said ATA/ATAPI device can perform properly, the interface translator will inform the host system that a new ATA/ATAPI is added (step 25). Then, the interface translator will start to transform the data formatted according to the interface of the host system to the ATA/ATAPI format, or vice verse. After several transaction, interface translator will verify Caddy's condition (step 27). If caddy is removed by user, or failed, then interface translator will inform host system (step 28), and go back to the end (step 29). Through these steps, a safety hot plug, or plug-and-play PnP, function is provided to any host system.

Although the present invention has been disclosed in the preferred embodiment, it is not used to restrict the present invention. It should be appreciated by persons skilled in the art that changes and modifications may be made to the present invention without departing from the spirit and scope of the invention. Thus, the present invention is protected by appended claims.

What is claimed is:

1. A portable and interface exchangeable storage system for communicating an ATA/ATAPI device with a host, comprising a caddy connector connecting to the ATA/ATAPI device located on an ATA/ATAPI device slot, the caddy connector comprising;
a connecting body,
a first ATA/ATAPI interface for interfacing the ATA/ATAPI interface on the ATA/ATAPI device;
an interface translator installing between the portable caddy and a host for translating between a general used interface in the host and an ATA/ATAPI interface so that the ATA/ATAPI device is communicated with the host, the interface translator further comprising:
a second ATA/ATAPI interface for interfacing with the ATA/ATAPI device through the caddy connector,
a power unit controlling the power supplied to the ATA/ATAPI device; and
a device setup unit for setting the ATA/ATAPI device so as to initiate the ATA/ATAPI device.

2. The portable and interface exchangeable storage system for communicating an ATA/ATAPI device with a host as claim in claim 1, wherein the ATA/ATAPI device is selected from one of a group containing Hard disks, ROMs, CDROMs, DVDROMs, CD-R, CD-R/W, DVD-R, DVD-R/W, EPROMs, PROMs, EEPROMs, and Flash memory compatible with ATA/ATAPI interface.

3. The portable and interface exchangeable storage system for communicating an ATA/ATAPI device with a host as claim in claim 1, wherein the caddy connector and the ATA/ATAPI device are packaged in one box.

4. A method for actuating a portable and interface exchangeable storage system for communicating an ATA/ATAPI device with a host; the system comprising a caddy connector and interface translator; and the caddy connector having a connector body and an ATA/ATAPI interface having an second ATA/ATAPI interface, a power unit, a caddy plug detection unit and a device setup unit; the method comprising the step of:
(a. 1) checking whether a caddy connector is connected to an ATA/ATAPI device;
(a. 2) if no caddy connector exist, then the process returning to (a. 1) for waiting a caddy connector;
(a. 3) if the caddy connector exist, providing power to the ATA/ATAPI device for booting up the ATA/ATAPI device through the power unit of the interface translator;
(a. 4) setting up the ATA/ATAPI device through a device setting unit in the interface translator;
(a. 5) informing the host that the ATA/ATAPI device has been set up so that the communication can be performed there between; and
(a. 6) starting interface translating process at the interface translator for translating data with a format according to an interface of the host into a format of the ATA/ATAPI interface or translating the data with the format according to the ATA/ATAPI interface into the format of the interface of the host.

5. A method for actuating a portable and interface exchangeable storage system for communicating an ATA/ATAPI device with a host as claim in claim 1, wherein the step (a. 6) further comprises the step of the caddy connector is removed, the interface translator informs the host.
